(19) United States
(12) Patent Application Publication
(10) Pub. No.: US 2011/0319063 A1
(43) Pub. Date: Dec. 29, 2011

(54) METHODS SYSTEMS AND COMPUTER PROGRAM PRODUCTS FOR MASKING PHONE NUMBERS OF COMMUNICATION DEVICES

(75) Inventors: Vishnu Nanda, Bangalore (IN); Sagar Dutta, Bangalore (IN); Anup P. Mutalik, Bangalore (IN); Kashinath Kakarla, Bangalore (IN); Shirish K. Peshwe, Bangalore (IN); Mandar A. Kale, Bangalore (IN); Gerald Huff, Berkeley, CA (US)

(73) Assignee: INTUIT INC., Mountain View, CA (US)

(21) Appl. No.: 12/821,735

(22) Filed: Jun. 23, 2010

(51) Int. Cl. H04W 4/00; H04M 3/42

(52) U.S. Cl. 455/416; 455/414.1

(57) ABSTRACT

Communications involving mobile communication devices and an intermediate compute of a trusted third party host such that people can communicate with each other through the intermediate computer while not disclosing their phone numbers and/or other contact information to each other. Users register with the intermediate computer using a first form of communication that may involve non-voice communications such as text messages. After registration, users may communicate with each other through the intermediate computer using the same or different form of communication. For example, after registering with the intermediate computer via text messages, users may communicate with each other through a voice connection established through the intermediate computer.

### BACKGROUND

The invention relates to exchanging contact information using communication devices including mobile communication devices. Mobile communication devices are used extensively and relied upon for personal and business communications throughout the world, particularly in occupations and geographic locations in which mobile communication devices are the primary form of communication. Thus, mobile phone numbers are very important and in many cases serve as the primary contact information for family members, clients, business associates, etc. Many people rely solely on their mobile communication devices as their primary or only form of communication, particularly in locations where cellular infrastructure is the primary infrastructure, e.g., in emerging markets.

Mobile phone numbers, however, can be stolen and unknowingly provided to or utilized by others who then use mobile phone numbers improperly. For example, a mobile phone owner may be subjected to spam calls, calls at irregular hours and text message advertisements. These problems are compounded as one advertiser who obtained a mobile phone number provides or sells that number to other advertisers who then send the owner even more spam and text advertisements. Thus, once a mobile phone number is no longer protected, it can be distributed very quickly and utilized for improper purposes. Despite these risks, people often give out their mobile numbers due in part because they have no other choice—they must provide their mobile number so that others can contact them on their mobile phone for personal and business. Thus, people often accept the risk that their mobile numbers may be improperly utilized.

The recourse for improper use of mobile numbers is limited. It may be necessary to obtain a new mobile number since a mobile phone owner may constantly receive spam calls and text messages. This results in a different set of significant inconveniences since the new mobile number must then be distributed to the trusted circle of family, friends and business associates. Such changes and updates may have to be done occasionally depending on the amount of spam calls and text messages sent to mobile communication devices. Thus, this not only presents an ongoing inconvenience to the mobile phone owner but also to those who need to contact the owner since changing the mobile phone number may result in friends, family and business associates losing or not remembering the new number, particularly if the old mobile number was utilized often and remembered or programmed into speed dial.

These issues are particularly concerning when mobile phone owners are required to communicate with people they have not met before since they do not know who knows their mobile phone number. This is common when the owner meets or is required to work with new people or business contacts. It may be the case that the owner is forced to disclose the mobile phone number to various strangers whom the owner will communicate with by phone but never meet in person.

### SUMMARY

One embodiment of the invention is directed to a method for facilitating communications between mobile communication devices and comprises receiving, from a first mobile communication device of a first person and at an intermediate computer of a host through a first network, a first mobile number of the first person and receiving, from a second mobile communication device of a second person and at the intermediate computer through a second network, a second mobile number of the second person. The first and second mobile numbers are transmitted from respective mobile communication devices to the intermediate computer using a first communication protocol, which may be a non-voice communication protocol. The method further comprises establishing a connection between the first and second mobile communication devices while masking the first and second mobile numbers. In this manner, the first and second persons can communicate with each other through the intermediate computer using a different, second communication protocol such as a voice communication protocol while not disclosing their respective mobile communication numbers to each other as a result of communicating through the intermediate computer of a trusted host.

Another embodiment is directed to a method for facilitating communications between mobile communication devices and comprises receiving respective first and second registration data at the intermediate computer from respective first and second mobile communication devices of respective first and second persons through respective first and second networks. The first and second registration data comprises respective first and second mobile numbers that are sent to the intermediate computer using a first communication protocol such as a non-voice communication protocol. The method further comprises mapping, associating or relating respective first and second unique identifiers to respective first and second persons or first and second registration data and sending a common or shared telephone number of the intermediate computer to the first and second mobile communication devices using the first communication protocol. The method further comprises establishing a connection between the first and second mobile communication devices and through the intermediate computer utilizing the intermediate computer phone number and the first and second unique identifiers while masking first and second mobile numbers. In this manner, the first and second persons can communicate with each other using a different, second communication protocol such as a voice protocol while not disclosing their respective mobile communication numbers to each other as a result of communications through the intermediate computer of a trusted host.

A further embodiment is directed to a method for facilitating communications between mobile communication devices such as cellular telephones and comprises utilizing a non-voice communication such as text or SMS messaging to determine which persons should contact each other and a voice communication such as cellular communications for when it is determined that first and second persons should communicate with each other. The method comprises receiving respective first and second registration data at the intermediate computer and from respective first and second cellular telephones of respective first and second persons through respective first and second cellular networks. The first and second registration data comprises respective first and second mobile numbers, first criteria of the first person related to a first need or objective of the first person, and second criteria of the second person related to a second need or objective of the second person. For example, the first criteria may relate to a job opening posted by the first person, and the second criteria may relate to experience and qualifications of an employee sought by the first person. As another example, the first criteria may relate to a needs of a business or business owner (e.g., materials, parts, labor, services, etc.), and the second criteria may be submitted by a contractor, supplier, manufacturer, etc. The first and second registration data are sent to the intermediate computer as respective first and second non-voice messages such as text or SMS messages, and respective first and second unique identifiers are mapped, associated or related to the first and second persons or their first and second mobile numbers. A common or shared telephone number of the intermediate computer is sent to the first and second cellular telephones as respective third and fourth non-voice messages. The intermediate computer compares the first and second criteria utilizing the intermediate computer to determine whether the first and second criteria match or whether pre-determined criteria are satisfied. If so, then respective fifth and sixth non-voice messages are sent from the intermediate computer to respective first and second cellular telephones to inform the first person of the second need or objective of the second person and to inform the second person of the first need or objective of the first person. At a later time, a first request sent by one of the first and second persons is sent requesting that the person be connected to the other person. The first request is sent from the cellular telephone of the person transmitting the first request as a seventh non-voice message. A connection between the first and second cellular telephones is established through the intermediate computer utilizing the intermediate computer phone number and at least one of the first and second unique identifiers while masking first and second mobile numbers such that the first and second persons can talk to each other while not disclosing their respective mobile numbers to each other.

Thus, with method embodiments, people can communicate with each other without having to disclose their mobile numbers, which may be the primary numbers used for personal and business matters and thus are very important and valuable, thereby preventing or reducing the likelihood that their mobile numbers will be used for improper purposes such as spam calls and calls outside of normal working hours. Embodiments protect important contact information by using a trusted intermediate party or host, and communications with the host may involve different communication protocols depending on the communication devices utilized. For example, with a mobile communication device, initial communications may be via text or SMS and subsequent communications may be by voice.

Embodiments can be used to mask mobile and non-mobile or land line numbers even if such numbers are public or listed since embodiments function separately of the existing public telephone system, and the connection that is eventually established uses the existing public telephone system, e.g., using telephone number formats and protocols.

Additional embodiments are directed to a computer program product, tangible medium or article of manufacture comprising a computer program carrier readable by the intermediate computer. The computer program carrier comprises instructions that are executable to perform method steps of various embodiments.

Yet another embodiment is directed to a system for facilitating communications between communication devices such as mobile communication devices. The system comprises an intermediate or host computer and a masking program executing on the intermediate computer or on another computer associated with and accessible by the intermediate computer through a network. The intermediate computer serves as a trusted host and is operable to communicate with a first mobile communication device of a first person through a first network and with a second mobile communication device of a second person through a second network using a first communication protocol, e.g., a non-voice communication protocol. The masking program is configured, operable or executable to receive, from the first mobile communication device, a first mobile number of the first person and a second number of the second person using a first communication protocol, and to establish a connection between the first and second mobile communication devices. The masking program is configured or operable to establish and maintain the connection while masking the first and second mobile numbers such that the first and second persons can communicate with each other through the intermediate computer using a second communication protocol such as a voice protocol I while not disclosing their respective mobile communication numbers to each other.

A further embodiment is directed to a system for facilitating communications between mobile communication devices and comprises an intermediate computer that is operable to communicate with a first mobile communication device of a first person through a first network and with a second mobile communication device of a second person through a second network. These communications involve a first communication protocol such as a non-voice communication protocol. A masking program resides on the intermediate computer or on another computer that is associated with and accessible by the intermediate computer through a communications link or network. The masking program is configured or executable to receive respective first and second registration data from respective first and second mobile communication devices of respective first and second persons. The first and second registration data comprise respective first and second mobile numbers that are sent to the intermediate computer using the first communication protocol. The masking program is configured or executable to map, associate or relate respective first and second unique identifiers to the first and second persons or their respective first and second registration data, send a common telephone number of the intermediate computer to the first and second mobile communication devices using the first communication protocol, and establish a connection between the first and second mobile communication devices and through the intermediate computer utilizing the intermediate computer phone number and at least one of the first and second unique identifiers. This is done while masking first and second mobile numbers such that the first and second persons can communicate with each other using a second communication protocol such as a voice communication protocol while not disclosing their respective mobile communication numbers to each other.

An additional embodiment is directed to a system for facilitating communications between mobile communication devices and comprises an intermediate computer that is operable to communicate with a first mobile communication device of a first person through a first network and with a second mobile communication device of a second person through a second network using a first communication protocol and a masking program that executes on the intermediate computer or on another computer associated with and accessible by the intermediate computer. The masking program is configured, operable or executable to receive respective first and second registration data from respective first and second cellular telephones of respective first and second persons through respective first and second cellular networks. The first and second registration data comprise respective first and second mobile numbers, first criteria of the first person related to a first need or objective of the first person, and second criteria of the second person related to a second need or objective of the second person. The first and second registration data is received by the intermediate computer as respective first and second text or SMS messages. The masking program is also configured, operable or executable to map, associate or relate respective first and second unique identifiers to respective first and second mobile numbers or users thereof, send a common telephone number of the intermediate computer to the first and second cellular telephones as respective third and fourth text or SMS messages, compare the first and second criteria utilizing the intermediate computer, determine whether the second criteria matches the first criteria or satisfies pre-determined criteria, and if the second criteria matches or satisfy pre-determined criteria, and send respective fifth and sixth text or SMS messages from the intermediate computer to respective first and second cellular telephones to inform the first person of the second need or objective of the second person and to inform the second person of the first need or objective of the first person. A first request by one of the first and second persons to be connected to the other is received at the intermediate computer and is transmitted from the cellular telephone of the person transmitting the first request as a seventh text or SMS message. The masking program is configured, operable or executable to establish a connection between the first and second cellular telephones through the intermediate computer utilizing the intermediate computer phone number and at least one of the first and second unique identifiers while masking first and second mobile numbers such that the first and second persons can talk to each other while not disclosing their respective mobile numbers to each other.

In a single or multiple embodiments, the communication device is a mobile communication device such as a cellular telephone, Smartphone or other mobile communication device capable of communicating with the host or intermediate computer via wireless or cellular communications, e.g., using text or SMS, wireless and/or cellular communication protocols. For example, the first communication protocol utilized for preliminary communications between a mobile communication device and the intermediate computer may be performed using a text or SMS messages, and communications between mobile communication devices through the intermediate computer may be performed with a cellular or voice communications. The masking program may be operable to establish a connection for cellular or voice communications by establishing a connection such as a conference call including the persons having mobile communication devices.

In a single or multiple embodiments, the intermediate computer and masking program are utilized to mask mobile numbers for preliminary discussions between first and second persons, who may then engage in later discussions directly independently of the intermediate or host computer during which the first and second persons may exchange their mobile numbers.

For example, embodiments may involve an employer and a candidate applying for employment with the employer. Initial communications may involve non-voice communications such as text or SMS sent from the mobile communication devices utilized by the employer and employee to register with the intermediate computer of a trusted host. Employees and employers who are matched may then communicate with each other via voice through the intermediate computer while the intermediate computer masks their respective mobile numbers. If the employer wants to hire or interview the candidate or if they work with each other, the employer and candidate may exchange their mobile numbers.

As another example, embodiments may involve an owner or employee of a business and a supplier, contractor or service provider seeking to work with the owner or employee. The intermediate computer or masking program may also be operable to select certain candidates for the employers to review or certain suppliers, contractors and service providers for the owner or employee to review based upon the needs or objectives of the employer, owner or employee (e.g., based upon goods, services or prices desired) qualifications and services provided by the candidates, suppliers, contractors and services providers. Thus, embodiments may involve two people or tens, hundreds and thousands of people, some of which may be selected by the intermediate computer or masking program based on criteria comparison, such that when there is a match or the submitted criteria match pre-determined criteria, information about each other can be sent through the intermediate computer to inform each other about qualifications, services, experience, etc.

In a single or multiple embodiments, whether a connection is established depends at least in part upon whether contact criteria such as date and time of day are satisfied. For example, upon receiving a request by one person to contact another person through the intermediate computer of the trusted host, the masking program may determine the date and time of the request and compare that data to one or more contact preferences specifying when it is acceptable to contact the other person.

In a single or multiple embodiments, the first and second persons provide their mobile numbers to the intermediate computer, which then associates respective unique codes to those persons or their mobile numbers and sends a telephone number of the intermediate computer with the unique codes to the first and second persons. The first person receives the intermediate computer phone number and the unique code of the second person that is appended to the intermediate computer phone number, e.g., as a suffix of DTMF tones, and the second person receives the intermediate computer phone number and the unique code of the first person that is appended to the intermediate computer phone number, e.g., as a suffix. In this manner, a connection can be established when the first person dials the intermediate computer phone number and the second unique code using the first mobile communication device or when the second person dials the intermediate phone number and the first unique code using the second mobile communication device while the intermediate computer is transparent to the first and second persons.

The unique code may be appended to the intermediate computer phone number, and separated by an intermediate indicator such as a pause or wait indicator, e.g., of the tel Uniform Resource Identifier protocol, that identifies an end of the intermediate computer phone number and a beginning of the first unique identifier, which is then read by the masking program when the dual-tone multi-frequency key string is dialed to look up the mobile number of the person to be contacted and to establish a conference call while masking the mobile numbers.

In a single or multiple embodiments, the first and second unique identifiers that are associated with or assigned to respective mobile numbers are single use identifiers. Thus, after a unique identifier is utilized to establish a connection, it is replaced with another unique identifier and used only one time. In an alternative embodiment, both unique identifiers of both people involved in a connection are replaced even if one unique identifier was part of the sequence of keys dialed to initiate the connection.

### BRIEF DESCRIPTION OF THE DRAWINGS

The foregoing and other aspects of embodiments are described in further detail with reference to the accompanying drawings, wherein:

FIG. 1 illustrates a system constructed according to one embodiment for masking phone numbers utilizing an intermediate host computer;

FIG. 2A is a flow diagram of one embodiment of a method for masking phone numbers utilizing an intermediate host computer, and FIG. 2B illustrates method steps relative to system components illustrated in FIG. 1;

FIGS. 3A-D illustrate types of data that may be submitted to an intermediate host computer, wherein FIGS. 3A-B illustrate examples of personal data and employment criteria submitted by a first person such as an employer, and FIGS. 3C-D illustrate examples of personal data and qualifications submitted by a second person such as an applicant or candidate;

FIG. 4 illustrates one manner in which a database or table of an intermediate computer and utilized by a masking program may be structured according to certain embodiments;

FIG. 5 illustrates one manner in which a database or table of an intermediate computer and utilized by a masking program may be structured to relate unique identifiers and mobile phone numbers according to certain embodiments;

FIGS. 6A-C and FIGS. 7A-C illustrate different dialing sequences that may be entered into a mobile communication device in which a unique identifier that is mapped to a mobile number is appended as a suffix to a telephone number of an intermediate host computer and separated there from by an intermediate indicator to indicate an end of the host computer number and a beginning of the unique identifier; and

FIG. 8 is a system diagram of a computing apparatus that may be utilized by various system components.

### DETAILED DESCRIPTION OF ILLUSTRATED EMBODIMENTS

Embodiments relate to allowing people to communicate with each other using their respective communication devices such as mobile telephones through a computing or communications device of a trusted third party that masks contact information such as mobile phone numbers. Thus, embodiments allow for communications while protecting phone numbers and/or other contact information to be masked. Embodiments may be utilized for both personal communications (e.g. family and friends) and business-related communications (e.g. employer-employee, manufacturer-supplier, etc.). Thus, embodiments allow two people, who may or may not have met before, to communicate with each other while not disclosing their phone numbers to each other.

With embodiments, first and second users register with a computer of a trusted third party using their respective communication devices such that post-registration communications are made through the third party computer. One manner in which embodiments may be implemented is by users registering with the third party computer using a first form of communication such as text messaging, and once registered, users may communicate with each other through the trusted third party computer using the same or different form of communication. For example, after registering via text messages, users may talk to each other through a connection established through the third party computer.

For example, in one embodiment involving mobile communication devices and business-related communications, owners of mobile communication devices provide their mobile phone numbers and may also provide other information or criteria related to their business, services, etc. to a trusted intermediate or host computer. According to certain embodiments, this information is provided to the intermediate computer using a first communication protocol such as a non-voice communication protocol. An employer or business owner may submit non-voice communications such as text or SMS messages to register with the intermediate host computer and specify criteria for new employees or candidates (e.g., one or more of company name, location, education, number of years experience, special skills, travel requirements, hours per week, employment duration, etc.). Potential new employees or candidates may register with the intermediate computer by sending non-voice communications such as text or SMS messages to the intermediate computer with the same or similar data.

Data submitted by the employer and candidates can be compared using a masking program executing on the intermediate computer to determine which candidates may be selected as the best matches for the position, in response to which the masking program can send non-voice communications such as text or SMS messages to the employer and candidates with information about each other. The employer and/or a candidate may request to be put into contact with the other, and a connection can be made through the intermediate computer by the requestor dialing an intermediate computer phone number and a unique code associated with respective mobile number of the person being called. This unique code is used by the masking program to lookup the mobile number of the person to be called and to establish a connection that allows the employer and candidate to talk to each other using their mobile communication devices while the mobile phone numbers are masked by the masking program.

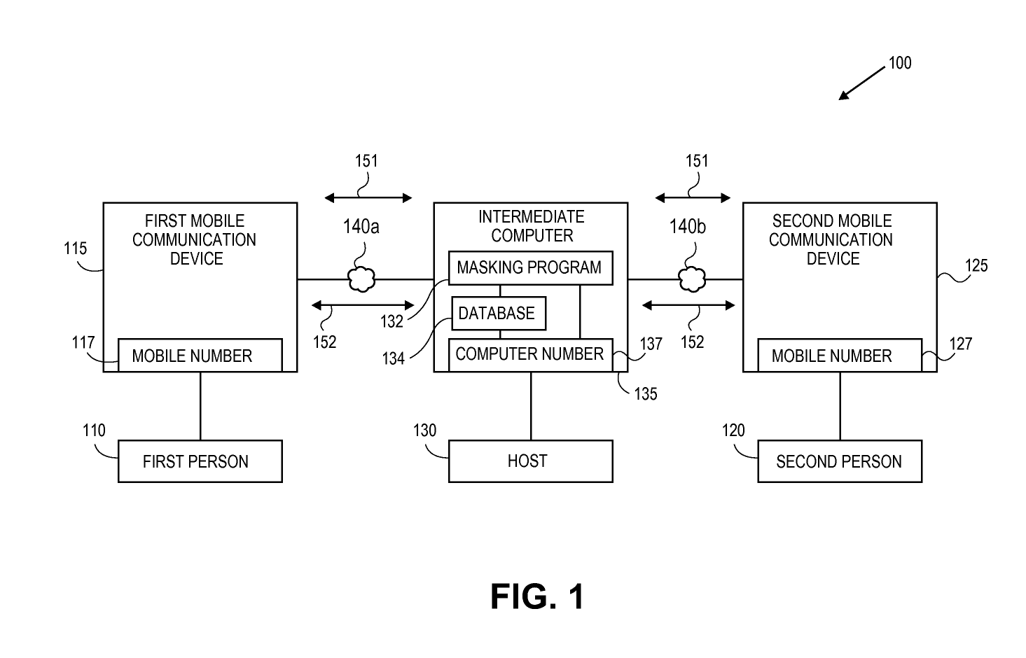

Thus, with embodiments, an intermediate computer may be utilized to perform bi-directional masking while providing a connection between communication devices, and the connection may be established using different types of data entry and communication protocols. In one embodiment, initial or preliminary communications with the intermediate computer can be masked or unmasked and can be done with non-voice communications such as text or SMS messages or other non-voice communications, and communications between parties can be done by the parties talking to each other, e.g., utilizing their cellular telephones. Then, if desired, e.g. if the parties know each other or are comfortable with each other, they may talk to each other directly or independently of the intermediate computer as is done in standard cellular telephone communications, which may involve disclosing mobile numbers to each other. Further aspects of embodiments and other embodiments are described with reference to FIGS. 1-8.

Referring to FIG. 1, a system 100 constructed according to one embodiment for facilitating communications between communication devices while masking contact information such as phone numbers includes or involves a first person, user or party 110 (generally, “first person”), a second person, user or party 120 (generally, “second person”) and a trusted third party or host 130 (generally, “host”). The first person 110 has a first communication device 115 such as a first mobile communication device to which is assigned a first mobile number 117, the second person 120 has a second communication device such as a second mobile communication device 125 to which is assigned a second mobile number 127. The host 130 manages an intermediate computer 135 and can be contacted with an intermediate computer number 137, which may be shared among multiple persons and mobile communication devices. The intermediate computer 135 is operably coupled to or in communication with the first and second mobile communication devices 115, 125 through respective networks 140a, 140b (generally, network 140).

One of the first and second persons 110, 120 wishes to speak with the other person for various personal or business-related reasons. For example, in embodiments involving business-related matters, the first person 110 may be a business owner or associate who is seeking assistance with certain tasks, desires to hire someone as an employee or a contractor, or is seeking business partners such as suppliers, manufacturers, and other service providers. The second person 120 may be a candidate for a job offered by the first person 110 or a potential business associate or partner such as a supplier, manufacturer or other service provider. Accordingly, a “person” is defined to include an individual, a corporate or government entity or an individual with the corporate or government entity, and it should be understood that the first and second persons 110, 120 may desire to communicate with each other for various personal and business-related reasons. For ease of explanation, reference is made to a “person,” and it should be understood that the first person 110 may be seeking someone with certain criteria or characteristics and the second person 120 may be seeking someone with certain criteria and characteristics, and embodiments described herein involving business relationships and employment are provided as non-limiting examples of how embodiments of the invention may be implemented

The first and second mobile communication devices 115, 125 are operable to communicate with the intermediate computer 135. Mobile communication device—intermediate computer communications may involve non-voice and/or voice communication protocols. Mobile communication devices 115, 125 that may be utilized in embodiments include, but are not limited to, a cellular telephone, a feature phone, a smart phone, a personal digital assistant (PDA) phone, tablet computing/communication devices, and other communication devices capable of communicating with the intermediary computer 135 with non-voice and/or voice communication protocols. Examples of mobile communication devices 115, 125 that may be utilized in embodiments include BlackBerry® and an iPhone®. BlackBerry® is a registered trademark of Research In Motion Limited Corporation, and iPhone® is registered trademark of Apple Inc. While specific examples of mobile communication devices 115, 125 are provided, it should be understood that embodiments may involve various types of mobile and non-mobile communication devices.

Data may be entered into a mobile communicate device 115, 125 using data input components such as a keyboard, display screen, user interface, scroll wheel, voice recognition and/or other suitable data input components of the mobile communications device 115, 125. The first and second persons 110, 120 and their mobile communication devices 115, 125 may be located in the same city, the same county, the same state and the same country or in different cities, different counties, different states and different countries. Thus, embodiments may apply to first and second persons 110, 120 who are looking for local connections or remote or world wide connections.

The trusted host 130 may be a third party host such as Intuit Inc. or another host who is a trusted intermediary to the first and second persons 110, 120. According to one embodiment involving business-related communications, the trusted host 130 receives and/or collects data about the needs or objectives of the first person 110 and the needs or objectives of the second person 120. In the embodiment illustrated in FIG. 1, a masking program 132 executes on the intermediate computer 135 and is configured, programmed or operable to mask mobile communication numbers 117, 127 as described in further detail below. The masking program 132 may reside on the intermediate computer 135 (as shown in FIG. 1) or on another or remote computer that is operably coupled to or associated with the intermediate computer 135 through a network such that the intermediate computer 135 can access and execute the masking program 132 and/or the data processed by the masking program 132 and results generated thereby. The intermediate computer 135 also includes a database or table 134 (generally, “database”) or other structure for storing data including data sent from the mobile communication devices 115, 125 to the intermediate computer 135.

The intermediate computer 135 is operably coupled to or in communication with respective first and second mobile communication devices 115, 125 through respective networks 140a, 140b. Each of the networks 140a-b (generally, network 140) and other networks 140 discussed herein may be different, or two or more networks 140 may be the same depending on the system configuration and communication device and communication protocols employed. One or more or all of the networks 140 may be, for example, a cellular network or a wireless network.

For example, with a mobile communication device 115, 125, the network 140 utilized may be a wireless network or a cellular network, e.g., WiFi or wireless local area networks that utilize the 802.11 wireless standard, wireless networks available in public places such as a library, a coffee shop, etc., a Global System for Mobile Communications (GSM) network, a code division multiple access (CDMA) network, or a time division multiple access (TDMA) or other suitable wireless or cellular networks capable of wirelessly connecting two computing or communication devices 115, 125 and communicating with the intermediate computer 135.

Through these and other suitable networks 140, mobile communication devices 115, 125 may communicate with the intermediate computer 135 with non-voice and/or voice communications such as text or Short Message Service (SMS) messages, Multimedia Message Service (MMS) messages, voice recognition and voice communications. It should be understood that the communications protocol, form of communications and associated programs employed may depend on the types and configurations of the communication devices 115, 125 and the intermediate server 135 utilized. Accordingly, reference to a network 140 generally and communications between communication devices 115, 125 and with the intermediate computer 135 are not intended to refer to a specific network or communications protocol, and it should be understood that embodiments can be implemented using various networks and combinations thereof and non-voice and/or voice communications.

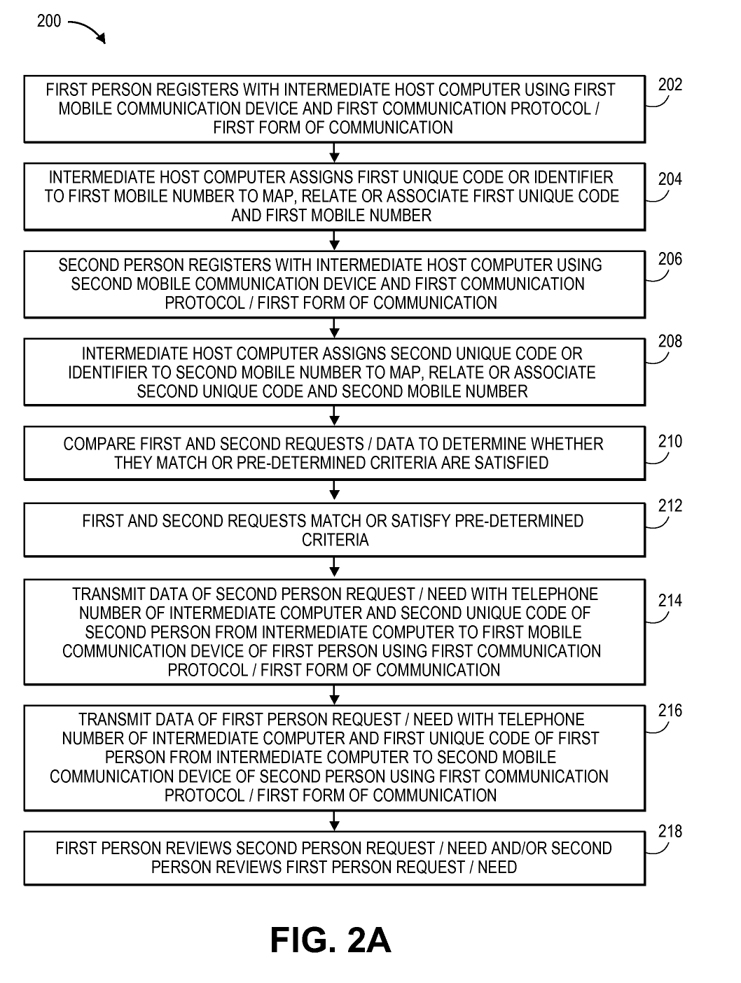

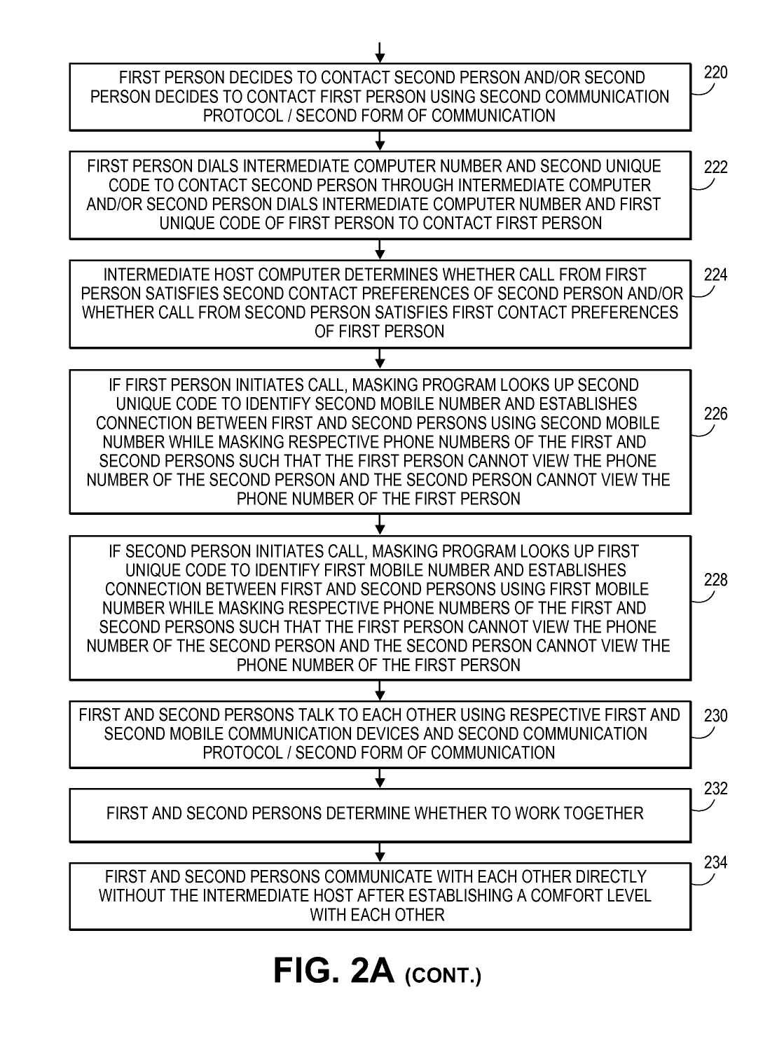

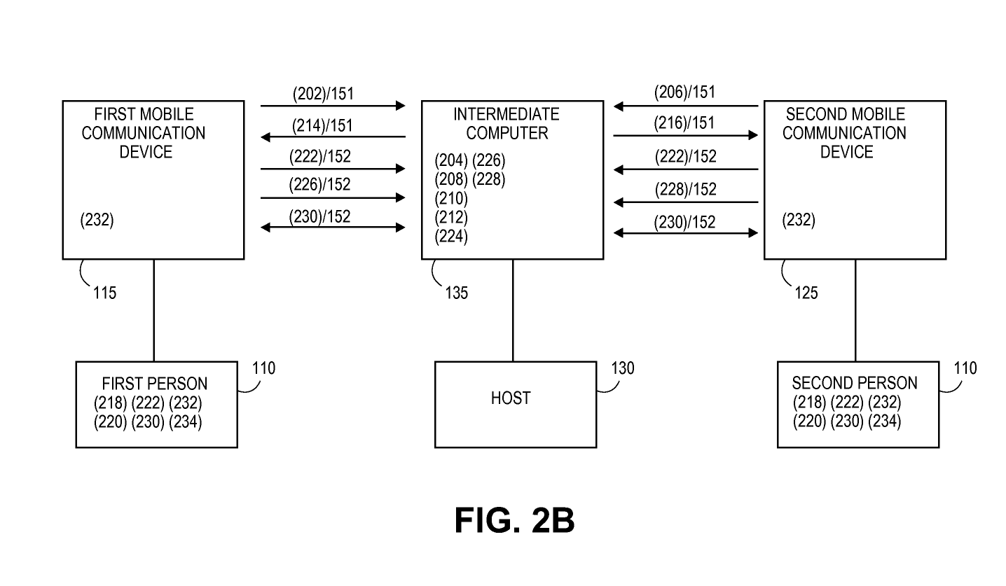

With reference to FIGS. 2A-B and with continuing reference to FIG. 1, a method 200 for facilitating communications between mobile communication devices 115, 125 using systems including the system 100 shown in FIG. 1 comprises, at step 202, the first person 110 registering with intermediate computer 135 using the first mobile communication device 115 and a first communication protocol or form of communication 151. According to one embodiment, the first communication protocol 151 or form of communication 151 is for non-voice communications such as, for example, text or SMS/MMS messaging (generally, text or SMS messaging).

Registration may involve the first person 110 providing personal or contact information such as the first person's mobile number 117. The information may also include other information such as name, company name, location and business type.

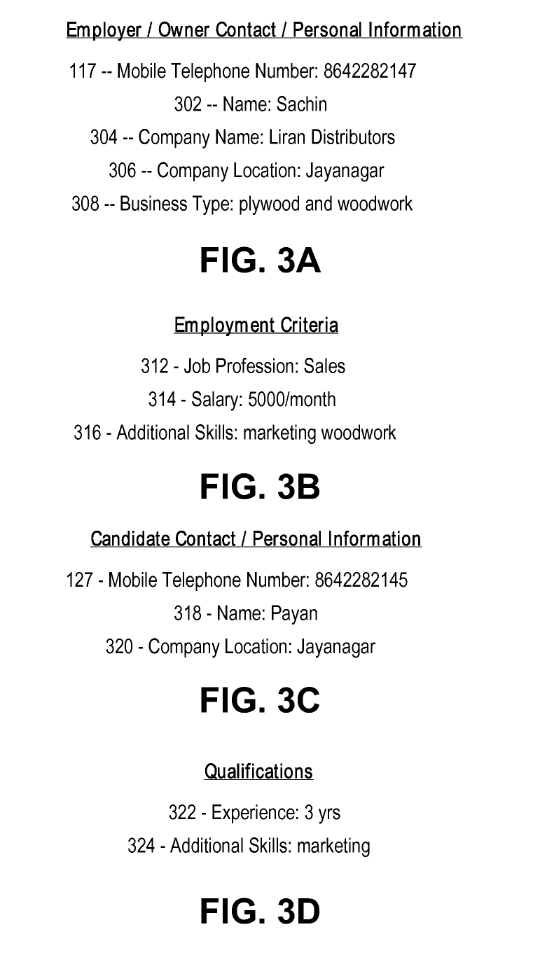

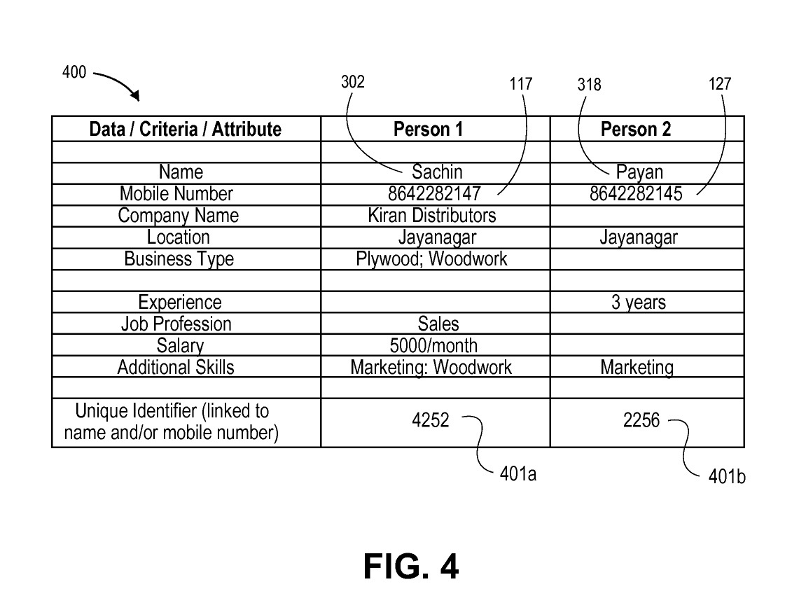

For example, in business-related embodiments, if the first person 110 is seeking an employee or new hire, the first person 110 may submit data related to what the first person 110 is seeking or requesting, e.g., employment criteria such as job type or title, location, salary, skills, travel, hours, and other criteria that may be required or important to the first person. Thus, registration involves the first person 110 submitting the mobile number 117 and/or other data as necessary related to why the first person 110 is seeking to establish a connection with another person. The connection between mobile communication devices 115, 125 through the intermediate computer 135 may be established using a common or shared telephone number and unique codes that are assigned to each person 110, 120 such that a first person 110 can call the second person 120 through the intermediate computer 130 using the shared telephone number and a second unique identifier identifying the second person 120, and the second person 120 can call the first person 110 through the intermediate computer 130 using the shared telephone number and a first unique identifier identifying the first person 110. For example, referring to FIG. 3A, the first person 110 may enter and the intermediate computer 135 may receive and store information such as Mobile Telephone Number 117: 8642282147, Name 302: Sachin, Company Name 304: Liran Distributors, Company Location 306: Jayanagar and Business Type 308: plywood and woodwork. It should be understood that more or less data may be entered and various types of data may be entered when registering with the intermediate computer 135. The first person 110 who, in one embodiment is an employer seeking to hire an employee or contractor, may also enter various employment criteria for candidates seeking to be considered by the employer. For example, referring to FIG. 3B, the criteria of the first person 110 or employer may include Job Profession 312: Sales, Salary 314: 5000/month and Additional Skills 316: marketing woodwork. It should be understood that more or less data may be entered and various types of data may be entered when registering with the intermediate computer 135. This data may be stored in one or more tables or databases 134 such as a table 400 utilized by the masking program 132 as generally illustrated in FIG. 4.

Referring again to FIG. 2 and with continuing reference to FIG. 4, the masking program 132 assigns a first unique code or identifier 401a to the first person 110 and/or to the first mobile number 117 of the first person 110 at step 204. In this manner, the masking program 132 maps, associates or relates the first unique code 401a to the first mobile number 117 of the first person 110. The first unique code 401a may be a randomly generated number or code or a number or code in a sequence of numbers and codes.

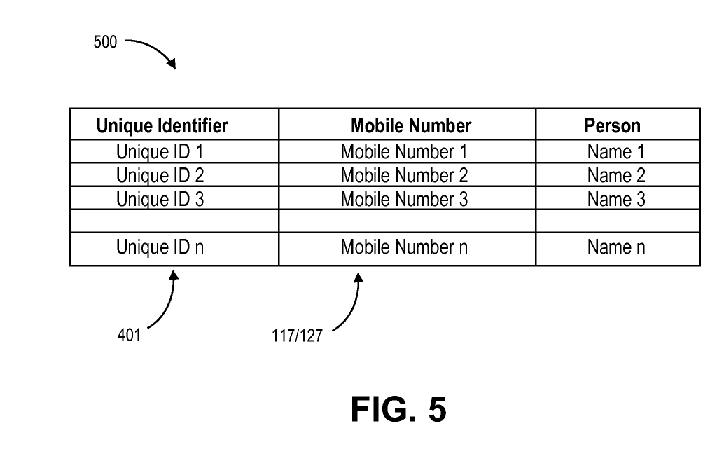

For example, continuing with the example of the first person 110 being an employer or business owner, business owner Sachin of Liran Distributors may be assigned unique code 401a of “4252,” which is mapped to or associated with the mobile number 8642282147 of the first person 110, business owner Sachin. This data may also be stored in one or more tables or databases and may be stored in the same table or database as other data discussed above (as shown in FIG. 4) or in a separate mapping table or database that is dedicated to relating mobile numbers to unique identifiers (as generally illustrated in FIG. 5).

Referring again to FIG. 2, at step 206, the second person 120 registers with intermediate host computer 135 using the second mobile communication device 125 and the first communication protocol 151 or form of communication such as a non-voice communication, e.g., text or SMS messaging, in one embodiment. For this purpose, and with further reference to FIG. 3C, the second person 120 may provide personal or contact information such as the second person's mobile number 127 and other information as necessary such as name 318, location 320 and/or other types of data. For example, referring to FIG. 3D, if the second person 120 is seeking to be hired, the second person 120 may submit data related to employment criteria or qualifications such as experience 322, skills 324 and other information such as references, available start date, travel, desired salary, desired number of hours, etc. Thus, registration involves the second person 120 submitting the mobile number 127 and, as necessary, other data related to the reason why the second person 120 is seeking to establish a connection with another person. This data may also be stored in one or more tables or databases and may be stored in the same table or database as other data discussed above (as shown in FIG. 4) or in a separate mapping table or database that is dedicated to relating mobile numbers to unique identifiers. This information can also be stored by the masking program 132 in the database or table 400 shown in FIG. 4.

Referring again to FIG. 2, the intermediate host computer 135 assigns a second unique code or identifier 401b to second mobile number 127 such that the second unique code 401b is mapped, associated with or related to the second mobile number 127 at step 208. The second unique code 502 may be a randomly generated number or code or a number or code in a sequence of numbers and codes. Continuing with the example of the second person 120 seeking employment with an employer or business owner, candidate Payan may be assigned unique code 401b “2256” that is mapped to or associated with the candidate's mobile communication number 8642282145 within the table 400. This data may also be stored in one or more tables or databases and may be stored in the same table or database as other data discussed above (as shown in FIG. 4) or in a separate mapping table or database that is dedicated to relating mobile numbers to unique identifiers.

The first and second and other unique codes 401a, 401b may be alpha-codes, numeric codes (as provided above) and alpha-numeric codes that are randomly generated, sequential or selected from a pre-determined set of allowable codes to ensure their uniqueness. The unique codes 401a, 401b may also include certain symbols. According to one embodiment, a unique code 401a, 401b is a string of keys or characters that can be pressed or dialed from a mobile communication device 115, 125 and thus, may include various numbers and combinations of letters, numbers and symbols that may be entered using, for example, dual tone multi-frequency (DTMF) keys. A unique code 401a, 401b may also include different numbers of letters, numbers and/or symbols. Thus, it should be understood that the examples of four number unique codes 401a, 401b shown in FIG. 4 are provided as illustrative examples of how embodiments may be implemented, and embodiments may involve codes of various lengths and that include letters, numbers and/or symbols.

Referring again to FIG. 2, after the first and second persons 110, 120 register with the intermediate host 130, at step 210, the masking program 132 compares the first request or data submitted by the first person 110 and the second request or data submitted by the second person 120 to determine whether they match or pre-determined criteria are satisfied. For example, in embodiments in which the first person 110 is an employer, the employer may require or prefer that a candidate match or satisfy all of the specified employment criteria (such as one or more of location, salary, experience, etc.) in order to be considered for employment. In other embodiments, the employer may require that a candidate satisfy a minimum number or specific pre-determined criteria in order to be considered for employment. As a further example, in embodiments in which the first person 110 is a business, the first person 110 may require or prefer that suppliers supply a certain part or component for a certain price or be able to supply a minimum number of components by a certain date.

If the masking program 132 determines that the first and second requests match or satisfy pre-determined criteria at step 212, then at step 214, data of the request or need of the second person 120 is transmitted from the intermediate computer 135 to the first mobile communication device 115 together with the telephone number 139 of the intermediate computer 135 and the second unique code 401b of the second person 120, and at step 216, data of the request/need of the second person 120 is transmitted from the intermediate computer 135 to the second mobile communication device 115 of the second person 120 together with the telephone number 137 of the intermediate computer 135 and the first unique code 401a of the first person 110. Communications during steps 214-216 may be performed using the first communication protocol 151, which may involve non-voice communications such as text or SMS messaging.

Thus, during steps 212-214, the masking program 132 informs the first person 110 or employer of a second person 120 or candidate who is interested in employment and satisfies certain criteria and also informs the candidate of the employer and what the employer is looking for in candidates. In this manner, the masking program 132 serves as a filtering mechanism by analyzing criteria of the employer and the candidate and informing the employer and the candidate of opportunities that may be mutually beneficial and of interest to both parties. Further, by providing the telephone number 137 of the intermediate computer 135 and the unique codes 401a, 401b, the masking program 132 provides a way for the first person 110 to contact the second person 120 and a way for the second person 120 to contact the first person 110.

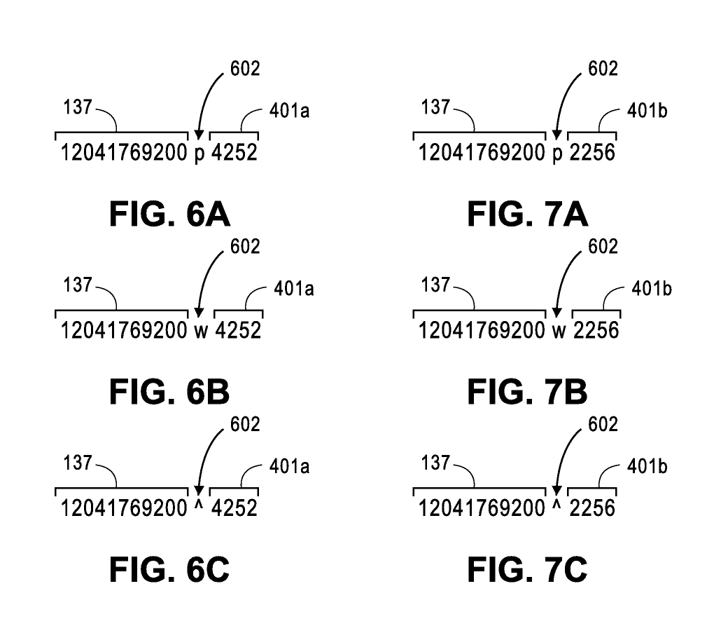

More particularly, referring to FIGS. 6A-C, in the illustrated embodiments, the first unique identifier 401a of the first person 110 is a suffix that is appended to the intermediate computer phone number 137 (1204176900) for dialing by the second person 120 in order to call the first person 110. For example, the first unique identifier 401a of the first person 110 may be a first dual-tone multi-frequency key string (“4252” in the illustrated example) that is appended to the intermediate computer telephone number 137 that can be dialed by the second person 120 to contact the first person 110.

FIGS. 7A-C illustrate similar intermediate computer telephone number 137 and unique identifier 401b configurations that may be utilized to allow the first person 110 to contact the second person 120 by dialing the intermediate computer number 137 and the appended suffix of the second unique identifier (“2256” in this example) of the second person 120.

Depending on the telephone protocol employed, the intermediate computer phone number 137 and the first unique identifier 401a, and the intermediate computer phone number 137 and the second unique identifier 401b, may be separated by an intermediate indicator or delimiter 602 that identifies an end of the intermediate computer phone number 137 and a beginning of a unique identifier. For example, in embodiments that utilize a Uniform Resource Identifier scheme or protocol (tel URI), the intermediate indicator 602 may be a “p” or pause indicator (as shown in FIGS. 6A and 7A), a “w” or wait indicator (as shown in FIGS. 6B and 7B), or another marker or symbol (as shown in FIGS. 6C and 7C) to indicate the end of the intermediate computer telephone number 137 and the beginning of a unique indicator 401a, 401b. Further details regarding the tel URI scheme or protocol are provided at http://www.faqs.org/rfcs/rfc3966.html, the contents of which are incorporated herein by reference as though set forth in full.

Given the manner in which embodiments allow first and second persons 110, 120 to dial numbers on their mobile communication devices 115, 125, embodiments provide a high degree of transparency since they are accustomed to without other special codes or procedures, other than the unique identifier 401a, 401b suffixes that can be dialed with the number 137 of the intermediate computer 130. It should be understood, however, that embodiments may be implemented utilizing different methods of establishing a connection through the intermediate computer

At step 218, the first person 110 or employer reviews the second person's qualification or employment criteria, and/or the second person 120 or candidate reviews the first person's requirement or candidate qualifications. At step 220, at least one of the first and second persons 110, 120 decides to contact the other to discuss employment or business opportunities based on the information received from the intermediate computer 130. For this purpose, at step 222, if the first person 110 or employer initiates a call, the first person 110 dials the telephone number 137 of the intermediate computer 130 and the suffix of the second unique code 401b, and if the second person 120 or candidate initiates a call, the second person 120 dials the telephone number 137 of the intermediate computer 130 and the first unique code 401a.

At step 224, the intermediate computer receives the call made from a mobile communication device and, according to certain embodiments, determines whether contact preferences are satisfied before establishing a connection between the first and second mobile communication devices 115, 125. For example, the first person 110 and/or second person 120 may have also submitted contact preferences such as certain dates, ranges or dates, certain times or ranges of times when calls will be accepted to the intermediate computer 135 during the registration steps. Thus, in one embodiment, the method 200 includes step 224, which involve comparing attributes of the request (e.g., date and time) and a contact preference of the person to be called to determine whether the connection can be established based at least in part upon the comparison.

For example, if a person specifies a contact preference that the person can be contacted during normal business hours of 9 am to 5 pm, and a request to contact the person at 4 pm may be permitted by the masking program 132, which may then proceed to steps 226-228. However, if the request to contact the person is received at the intermediate computer 135 at 8 pm, the masking program 132 does not proceed with the request and may also send a message, such as a text or SMS message using the first communication protocol 151, to the requestor indicating the person to be called does not accept calls at that time.

At stage 226, if the first person 110 initiates a call to the second person 120, then the masking program 132 looks up the second unique code 401b that was dialed by the first person 110 with the intermediate computer number 137 to identify the second mobile number 127. The masking program 132 then establishes a connection between first and second mobile communication devices 115, 125 using the second mobile number 127 while masking respective phone numbers 117, 127 of the first and second persons 110, 120 such that the first person 110 cannot view the phone number 127 of the second person 120, and the second person 120 cannot view the phone number 117 of the first person 110.

Similarly, at stage 228, if the second person 120 initiates a call to the first person, the masking program 132 looks up the first unique code 401a that was dialed by the second person 120 with the intermediate computer number 137 to identify the first mobile number 117. The masking program 132 then establishes a connection between first and second mobile communication devices 115, 125 using the first mobile number 117 while masking respective phone numbers 117, 127 such that the first person 110 cannot view the mobile number 127 of the second person 120 and the second person 120 cannot view the mobile number 117 of the first person 110.

According to one embodiment, the masking program 132 establishes a connection between the first and second mobile communication devices 115, 125 with a conference call that includes the first and second mobile communication devices 115, 125. For this purpose, the intermediate computer 135 may be connected into the conference call, but the host 130 does not participate in the call, which can be conducted privately between the first and second persons 110, 120. In another embodiment, the intermediate computer 135 establishes a connection by forwarding the call from one mobile communication device to the other through the intermediate computer 130.

At stage 230, the first and second persons 110, 120 talk to each other using their respective mobile communication devices 115, 125 through the intermediate computer 135 using a different, second communication protocol 152, e.g., a cellular communication protocol, and at step 232, they determine whether to work with each other and/or meet in person. At step 234, if the first and second persons 110, 120 are comfortable with each other, they may, if desired, share their mobile numbers 117, 127 with each other such that they can then communicate with each other directly without the intermediate computer 130 masking their mobile numbers 117, 127 from each other.

In a single or multiple embodiments, embodiments may utilize single use unique identifiers 401a, 401b, e.g., to enhance security and privacy of the mobile communication numbers 117, 127. In such embodiments, after a particular unique identifier is utilized to establish a connection through the intermediate computer 135, the unique identifier may be replaced with another unique identifier.

More particularly, according to one embodiment, one person dials the intermediate computer number 137 and a unique identifier 401a or 401b, and the unique identifier 401a or 401b that was dialed is replaced with a new unique identifier to provide further protection of mobile numbers 117, 127. According to another embodiment, both of the unique identifiers 401a and 401b (the unique identifier of the caller and the unique identifier of the recipient of the call) are replaced even though only one of the unique identifiers was dialed to establish the connection. A unique identifier can be replaced with another one-time unique identifier (e.g., based on a sequence) or a randomly generated unique identifier. In embodiments in which one-time unique identifiers are utilized, the masking program 132 can update the table (e.g., as shown in FIG. 4) that associates unique identifiers to mobile phone numbers 117, 127 to allow the same person to be reached by dialing the same intermediate computer phone number 137 but different unique identifier suffixes.

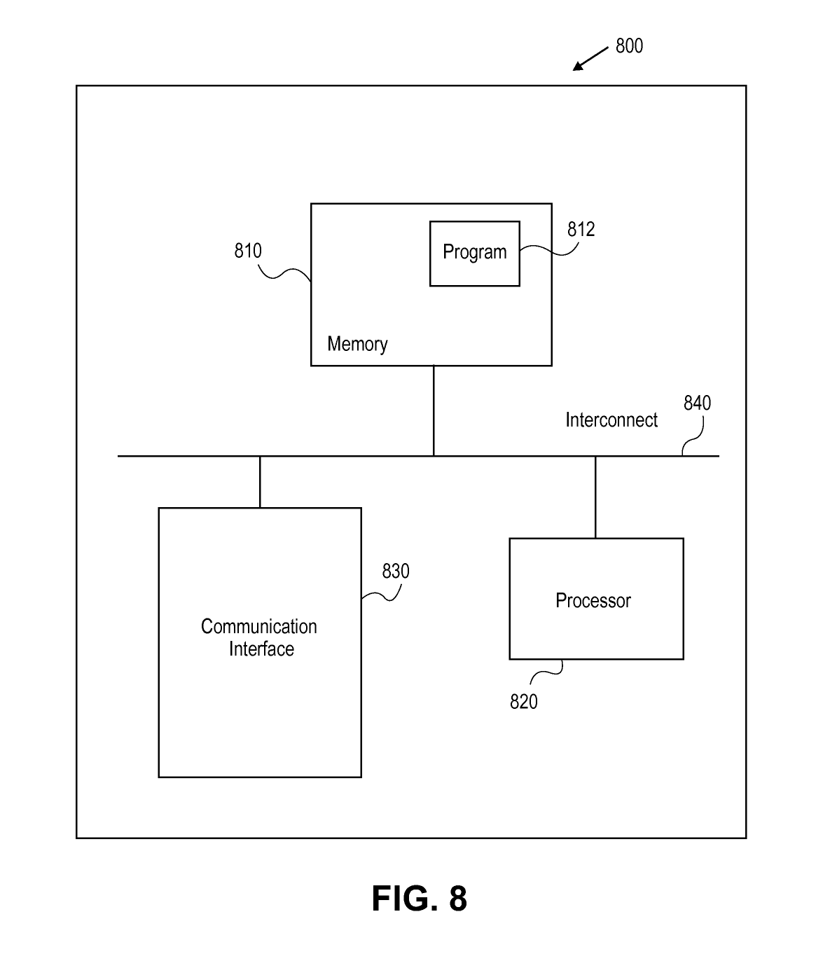

FIG. 8 generally illustrates components of a computing apparatus 800 that may be included in or utilized by one or more system 100. Such computing components may be, or include or utilize, a personal computer system, a desktop computer, a laptop or notebook computer, a mainframe computer system, a handheld computer, a workstation, a network computer, a consumer device, a mobile or cellular phone, a personal digital assistant (PDA), a smartphone, a PDA phone, a two-way paging device, an application server, a storage device, a peripheral device such as a switch, modem, router, or other suitable computing or communications device.

Components of a computing device 800 includes a memory 810, program instructions 812, a processor or controller 820, a network or communications interface 830, and connections or interconnect 840 between such components. For example, the memory 810 may be or include one or more of cache, RAM, ROM, SRAM, DRAM, RDRAM, EEPROM and other types of memory. The processor unit 820 may be or include multiple processors, a single threaded processor, a multi-threaded processor, a multi-core processor, or other type of processor. Depending on the particular system component (e.g., whether the component is a computer or a hand held mobile communications device), the interconnect 840 may include a system bus, LDT, PCI, ISA, or other types of buses, and the communications or network interface may, for example, be an Ethernet interface, a Frame Relay interface, or other interface. The network interface 830 may be configured to enable a system component to communicate with other system components across a network 140 which, as explained above, may be a wireless or various other networks. It is understood that any component of system 800 may be located remotely and accessed via a network. Accordingly, the system configuration provided in FIG. 8 is provided for ease of explanation and illustration to generally illustrate system components that may be utilized in various embodiments.

Method embodiments may also be embodied in, or readable from, a computer-readable medium or carrier, e.g., one or more of the fixed and/or removable data storage data devices and/or data communications devices connected to a computer. Carriers may be, for example, magnetic storage medium, optical storage medium and magnetooptical storage medium. Examples of carriers include, but are not limited to, a floppy diskette, a memory stick or a flash drive, CD-R, CD-RW, CD-ROM, DVD-R, and DVD-RW, or other carrier capable of retaining computer readable information. The processor 820 performs steps or executes program instructions 812 within memory 810 and/or embodied on the carrier to implement method embodiments.

Although particular embodiments have been shown and described, it should be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims.

For example, one embodiment is directed to using mobile phone or text messaging for submitting preliminary information to the intermediate computer and cellular communications for actual discussions with another person. Mobile phone text messaging (or text messaging) is defined to refer to written messages comprising text sent and/or received by mobile phones over cellular phone networks. While the most popular text messaging is the Short Message Service (SMS), text messaging as used herein also includes the Multimedia Message Service (MMS) which can be used for sending text along with multimedia such as videos, pictures, text pages and ringtones, and any other text messaging services for mobile phones now existing or implemented in the future.

Further, while embodiments are described with reference to a first person and a second person, it should be understood that embodiments may involve additional persons, e.g., tens, hundreds and thousands of persons. For example, an employer may register with the intermediate computer to provide data or criteria about a new position. One, ten or hundreds of job applicants or candidates may be registered with the intermediate computer such that when the masking program compares criteria of the employment opportunity posted by the employer and qualifications of the various applicants, the masking program may select one, two, three, ten, one hundred and other numbers of applicants such that information of multiple selected applicants is transmitted from the intermediate computer to the employer's mobile communication device, e.g., via text or SMS messaging, and information about the employment opportunity is transmitted from the intermediate computer to respective mobile communication devices of respective selected applications, e.g., via respective text or SMS messages. Thus, in such embodiments, each of the employer and the multiple selected applicants may have respective unique identifiers associated with their respective mobile numbers so that all of the mobile numbers are masked by the masking program.

Embodiments may involve the masking program selecting one or multiple people that match or satisfy pre-determined criteria such that a given person may want to contact or be contacted by one or multiple other people who may be within the same geographic area or located remotely relative to the given person, e.g., in a different city, state or country. Thus, the masking program may be operable to manage a small number of connections or hundreds, thousands and tens of thousands of connections depending on the number of registrants and criteria provided thereby.

Further, it should be understood that the masking program may compare criteria for exact matches (e.g., an employer states a minimum of three years of experience is required such that a person with 2.5 years of experience would not be selected by the masking program) or the masking program may be configured to account for some variance (e.g., as selected by an employer) such that the degree of permissible variance would select a candidate with 2.5 years experience.

Moreover, while embodiments have been described with reference to employer-applicant and business owner-supplier relationships, it will be understood that embodiments may be utilized in various other situations where connections between two or more people are desired, and such situations may involve employment and various business opportunities. For example, embodiments may also be utilized or adapted to mask electronic business card data such as telephone numbers and other contact information. Aspects of electronic business cards and exchange of electronic business card data through a routing apparatus that may be utilized are described in U.S. application Ser. No. 12/772,695, filed on May 3, 2010. Embodiments may also be utilized to mask data in healthcare or medical applications in which non-voice communications such as text or SMS messages are utilized as a low cost communication channel to exchange medical information that is not sensitive or confidential (e.g., alerts or reminders regarding a doctor's appointment) between a hospital and a patient while masking sensitive contact or medical information.

Further, while certain embodiments are described with reference to a single use unique identifier, embodiments may also involve multi-use, but limited use, of a unique identifier. For example, a unique identifier may be used two or three times, and such use may still provide additional protection of mobile numbers.

Moreover, embodiments may be utilized to mask various types of contact information including address information and/or telephone numbers including mobile and land line numbers.

While multiple embodiments and variations of the many aspects of the invention have been disclosed and described herein, such disclosure is provided for purposes of illustration only. Where methods and steps described above indicate certain events occurring in certain order, those of ordinary skill in the art having the benefit of this disclosure would recognize that the ordering of certain steps may be modified to be performed in different orders and/or in concurrently, and that such modifications are in accordance with the variations of the invention. Thus, the methods shown in various flow diagrams are not intended to be limited to a particular sequential order, particularly in instances in which certain steps may or may not be performed or may be performed simultaneously. Accordingly, embodiments are intended to exemplify alternatives, modifications, and equivalents that may fall within the scope of the claims.

1. A method for facilitating communications between mobile communication devices, the method comprising:
receiving, from a first mobile communication device of a first person and at an intermediate computer of a host through a first network, a first mobile number of the first person, the first mobile number being transmitted using a first communication protocol;
receiving, from a second mobile communication device of a second person and at the intermediate computer through a second network, a second mobile number of the second person, the second mobile number being transmitted using the first communication protocol; and
establishing a connection between the first and second mobile communication devices while masking the first and second mobile numbers such that the first and second persons can communicate with each other through the intermediate computer using a second communication protocol while not disclosing their respective mobile communication numbers to each other.

2. The method of claim 1, the first and second mobile communication devices comprising at least one of a cellular telephone and a Smartphone.

3. The method of claim 1, the first communication protocol comprising a non-voice communication protocol, and the second communication protocol comprising a voice communication protocol.

4. The method of claim 3, the first communication protocol comprising a text messaging protocol and the second communication protocol comprising a cellular communication protocol.

5. The method of claim 1, the connection comprising a conference call established by the intermediate computer.

6. The method of claim 1, after communicating with each other while respective first and second mobile numbers are masked by the intermediate computer, the first person and the second person communicate with each other directly and independently of the intermediate computer using the second communication protocol.

7. The method of claim 1, establishing the connection further comprising:
receiving a request from one of the first and second persons to contact the other person;
comparing attributes of the request and a contact preference of the other person; and
determining whether the connection can be established based at least in part upon the comparison.

8. The method of claim 7, the contact preference comprising at least one of a date or a range of dates the other person is willing to be contacted, and a time or a range of times the other person is willing to be contacted.

9. The method of claim 8, the second communication protocol comprising a voice communication protocol, and the contact preference comprising the other person is willing to be contacted if a time of a call to the other person is before a pre-determined time, the step of determining comprising determining that the request should not be granted such that the connection is not established by the intermediate computer if the time of the call is after the pre-determined time.

10. The method of claim 1, wherein the intermediate computer establishes the connection using an existing telephone system.

11. The method of claim 1, further comprising:
receiving, from the first mobile communication device and at the intermediate computer, first criteria related to a first need or objective of the first person, the first criteria being transmitted using the first communication protocol;
receiving, from the second mobile communication device and at the intermediate computer, second criteria related to a second need or objective of the second person, the second criteria being transmitted using the first communication protocol;
comparing the first and second criteria utilizing the intermediate computer; and
determining whether the second criteria matches the first criteria or satisfies pre-determined criteria, wherein if the second criteria matches the first criteria or satisfies pre-determined criteria, a first message is sent from the intermediate computer to the first mobile communication device to inform the first person of the second need or objective of the second person, the first message being in the first communication protocol, and a second message is sent from the intermediate computer to the second mobile communication device to inform the second person of the first need or objective of the first person, the second message being in the first communication protocol.

12. The method of claim 11, further comprising:
receiving, at the intermediate computer and from the first mobile communication device, a first request by the first person to be connected to the second person, the first request transmitted using the first communication protocol; and
establishing a connection between the first and second mobile communication devices and through the intermediate computer in response to the first request.

13. The method of claim 11, further comprising:
receiving a third mobile number and third criteria related to a third need or objective of the third person from a third mobile communication device of a third person at the intermediate computer through a third network, the third mobile number and the third criteria being transmitted using the first communication protocol;
comparing the first criteria to the second and third criteria utilizing the intermediate computer; and
determining whether the second and third criteria match the first criteria or satisfy pre-determined criteria, wherein if the second and third criteria match the first criteria or satisfies pre-determined criteria, a first message is sent from the intermediate computer to the first mobile communication device to inform the first person of the second and third needs or objectives of the respective second and third persons, a second message is sent from the intermediate computer to the second mobile communication device to inform the second person of the first need or objective of the first person, and a third message is sent from the intermediate computer to the third mobile communication device to inform the third person of the first need or objective of the first person, the first, second and third messages being transmitted using the first communication protocol.

14. The method of claim 11, wherein the first and second persons retain their anonymity with respect to each other while the first and second persons communicate with each other utilizing the second communication protocol.

15. A method for facilitating communications between mobile communication devices, the method comprising:
receiving respective first and second registration data at the intermediate computer and from respective first and second mobile communication devices of respective first and second persons through respective first and second networks, the first and second registration data comprising respective first and second mobile numbers sent to the intermediate computer using a first communication protocol;
mapping respective first and second unique identifiers to respective first and second registration data;
sending a common telephone number of the intermediate computer to the first and second mobile communication devices using the first communication protocol; and
establishing a connection between the first and second mobile communication devices through the intermediate computer utilizing the intermediate computer phone number and the first and second unique identifiers while masking first and second mobile numbers, wherein the first and second persons can communicate with each other using a second communication protocol while not disclosing their respective mobile communication numbers to each other.

16. The method of claim 15, the connection being established when the first person dials the intermediate computer phone number and the second unique code using the first mobile communication device or when the second person dials the intermediate phone number and the first unique code using the second mobile communication device.

17. The method of claim 15, the intermediate computer being transparent to the first and second persons during communication using the second communication protocol.

18. The method of claim 15, the first unique identifier comprising a first suffix that is appended to the intermediate computer phone number for dialing by the second person, and the second unique identifier comprising a second suffix that is appended to the intermediate computer phone number for dialing by the first person.

19. The method of claim 15, the intermediate computer phone number and the first unique identifier being separated by an intermediate indicator that identifies an end of the intermediate computer phone number and a beginning of the first unique identifier.

20. The method of claim 19, the intermediate indicator comprising a pause or wait indicator of a telephone communication protocol.

21. The method of claim 15, the first unique identifier comprising a first dual-tone multi-frequency key string that is appended to the intermediate computer telephone number for dialing by the second person, and the second unique identifier comprising a second dual-tone multi-frequency key string that is appended to the intermediate computer telephone number for dialing by the first person.

22. The method of claim 15, wherein the first and second unique identifiers are single use identifiers such that after the connection has been terminated, the unique identifier that was utilized to establish the connection is replaced with another unique identifier.

23. A method for facilitating communications between mobile communication devices, the method comprising:
receiving respective first and second registration data at the intermediate computer and from respective first and second cellular telephones of respective first and second persons through respective first and second cellular networks, the first and second registration data comprising respective first and second mobile numbers, first criteria of the first person related to a first need or objective of the first person, and second criteria of the second person related to a second need or objective of the second person, the first and second registration data being sent to the intermediate computer as respective first and second non-voice messages;
mapping respective first and second unique identifiers to respective first and second mobile numbers;
sending a common telephone number of the intermediate computer to the first and second cellular telephones as respective third and fourth non-voice messages;
comparing the first and second criteria utilizing the intermediate computer;
determining whether the second criteria matches the first criteria or satisfies pre-determined criteria;
if the second criteria matches or satisfy pre-determined criteria, sending respective fifth and sixth non-voice messages from the intermediate computer to respective first and second cellular telephones to inform the first person of the second need or objective of the second person and to inform the second person of the first need or objective of the first person;
receiving, at the intermediate computer, a first request by one of the first and second persons to be connected to the other, the first request being transmitted from the cellular telephone of the person transmitting the first request as a seventh non-voice message; and
establishing a connection between the first and second cellular telephones through the intermediate computer utilizing the intermediate computer phone number and the first and second unique identifiers while masking first and second mobile numbers such that the first and second persons can talk to each other while not disclosing their respective mobile numbers to each other.

24. A system for facilitating communications between mobile communication devices, the system comprising:
an intermediate computer of a host, the intermediate computer being configured to communicate with first and second mobile communication devices through respective first and second networks;
a masking program executing or accessible by the intermediate computer, the masking program being executable to
receive, from the first mobile communication device of a first person and at the intermediate computer through the first network, a first mobile number of the first person, the first mobile number being transmitted to the intermediate computer with a first communication protocol;
receive, from the second mobile communication device of a second person and at the intermediate computer through the second network, a second mobile number of the second person, the second mobile number being transmitted to intermediate computer with the first communication protocol, and
establish a connection between the first and second mobile communication devices while masking the first and second mobile numbers such that the first and second persons can communicate with each other through the intermediate computer using a second communication protocol while not disclosing their respective mobile communication numbers to each other.

25. The system of claim 24, further comprising the first mobile communication device and the second mobile communication device.

26. The system of claim 24, the first communication protocol comprising a non-voice communication protocol, and the second communication protocol comprising a voice communication protocol.

27. The system of claim 26, the non-voice communication protocol comprising a text messaging protocol and the voice communication protocol comprising a cellular communication protocol.

28-32. (canceled)
